(19) United States
(12) Patent Application Publication
(10) Pub. No.: US 2003/0002779 A1
(43) Pub. Date: Jan. 2, 2003

(54) Method and apparatus for switching signals between optical fibers using a sliced switch fabric

(76) Inventors: Vijayachandran Bobin, Sunnyvale, CA (US); Biswanath Mukherjee, Davis, CA (US)

Correspondence Address: PARK, VAUGHAN & FLEMING LLP, 508 SECOND STREET, SUITE 201, DAVIS, CA, 95616, US

(21) Appl. No.: 09/895,451

(22) Filed: Jun. 29, 2001

(51) Int. Cl. G02B 6/35

(52) U.S. Cl. 385/17

(57) ABSTRACT

One embodiment of the present invention provides a system for switching signals between optical fibers. Upon receiving a plurality of optical input signals, the system divides each of the optical input signals into N input slices, wherein each input slice carries 1/Nth of the data for a given input signal. Next, the system distributes the N input slices to N switching circuits. This allows the N input slices to be switched in parallel to N corresponding output slices. Next, the system forms a plurality of optical output signals, wherein a given optical output signal is formed by receiving N output slices from the N switching circuits, and splicing the N output slices together to form the given optical output signal.

### BACKGROUND

1. Field of the Invention

The present invention relates to optical communication networks. More specifically, the present invention relates to a method and an apparatus for switching signals between optical fibers using a sliced switch fabric structure.

2. Related Art

The explosive growth of the Internet and the recent proliferation of data-intensive applications, such as video-on-demand, have placed increasing demands on the existing network infrastructure. In order to keep pace with these increasing demands, communication networks have begun to use optical fibers to carry information.

Fiber optic communication networks are typically comprised of a number of optical cross-connects (OXCs) that are coupled together through optical fibers (for example, see FIG. 2). A message from a source is typically routed across a number of different optical fibers and a number of different optical cross-connects before arriving at a destination.

Each of these optical cross-connects switches signals between the different optical fibers. An exemplary optical cross-connect appears in FIG. 1. In this exemplary optical cross-connect, a number of optical fibers 122-125 feed into a number of demultiplexers 102-105. Demultiplexers 102-105 separate different wavelength-specific channels of data from the optical fibers, and the wavelength-specific channels of data are fed through a multi-stage Clos network containing non-blocking switches. Outputs of the non-blocking switches feed into multiplexers 112-115, which convert the outputs back into WDM optical signals. Note that the non-blocking switches in the first stage of the Clos network are used to switch 16 input signals into 31 output signals. This provides redundant communication pathways that allow more flexibility in routing signals through the optical cross-connect.

As optical networks become increasingly faster, optical cross-connects are coming under increasing pressure to provide additional bandwidth to handle larger volumes of data. One way to provide this additional bandwidth is to construct an optical cross-connect out of high-bandwidth switching elements. For example, in order to support a 10 G bit/second transfer rate, one can construct an optical cross-connect using 10 G bit/second switching elements.

However, high-bandwidth switching elements are often difficult to obtain, and may not be available for certain bandwidths. Moreover, even if highband-width switching elements can be obtained, they are often expensive, which can greatly increase the cost of an optical cross-connect. Another problem arises because high-bandwidth switching elements are typically lower-density, which means that a large number of lower-density components are needed to implement an optical cross-connect.

Hence, what is needed is a method and an apparatus for implementing a high-bandwidth optical cross-connect using low-bandwidth components.

### SUMMARY

One embodiment of the present invention provides a system for switching signals between optical fibers. Upon receiving a plurality of optical input signals, the system divides each of the optical input signals into N input slices, wherein each input slice carries 1/Nth of the data for a given input signal. Next, the system distributes the N input slices to N switching circuits. This allows the N input slices to be switched in parallel to N corresponding output slices. Next, the system forms a plurality of optical output signals, wherein a given optical output signal is formed by receiving N output slices from the N switching circuits, and splicing the N output slices together to form the given optical output signal.

In one embodiment of the present invention, all of the N switching circuits are configured in exactly the same way, so that all of the N input slices in a given optical input signal are switched to the same optical output signal.

In one embodiment of the present invention, the N switching circuits can be configured independently, thereby allowing each of the N input slices from a given optical input signal to be switched to different optical output signals. In a variation on this embodiment, each optical input signal can carry N constituent sub-streams that can be independently switched to different optical output signals.

In one embodiment of the present invention, splicing the N output slices together involves compensating for skew through the N switching circuits. In a variation on this embodiment, compensating for skew involves aligning synchronization characters that are periodically inserted into the input slices.

In one embodiment of the present invention, dividing each of the plurality of optical input signals involves converting the plurality of optical input signals from optical form into electrical form.

In one embodiment of the present invention, splicing the N output slices together to form the given optical output signal involves converting the given optical output signal from electrical form into optical form.

In one embodiment of the present invention, the plurality of optical input signals are received from neighboring nodes in an optical network, and the plurality of optical output signals are directed to back to the neighboring nodes.

In one embodiment of the present invention, dividing each of the optical input signals into N input slices involves performing a serial-to-parallel conversion on each of the optical input signals. Furthermore, forming the optical output signals involves performing a parallel-to-serial conversion to form each of the optical output signals.

In one embodiment of the present invention, each optical input signal supports at least one of the following standard Synchronous Optical Network (SONET) transfer rates: STS-1; OC-3; OC-12; OC-48; OC-192; OC-768; OC-1536; and OC-3072.

In one embodiment of the present invention, each of the N switching circuits can include, a single column of switching elements, a crossbar switch or a multi-stage network.

### BRIEF DESCRIPTION OF THE FIGURES

FIG. 1 illustrates a prior art optical cross-connect.

FIG. 2 illustrates a network of optical cross-connects in accordance with an embodiment of the present invention.

FIG. 3 illustrates an optical cross-connect in accordance with an embodiment of the present invention.

FIG. 4 illustrates a switching circuit made up of multiple lower-bandwidth switching circuits operating in parallel in accordance with an embodiment of the present invention.

FIG. 5A illustrates the structure of a slicer in accordance with an embodiment of the present invention.

FIG. 5B illustrates the structure of a splicer in accordance with an embodiment of the present invention.

FIG. 6 presents a flow chart of the switching process in accordance with an embodiment of the present invention.

FIG. 7 illustrates a switching circuit with traffic grooming capability in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Optical Network

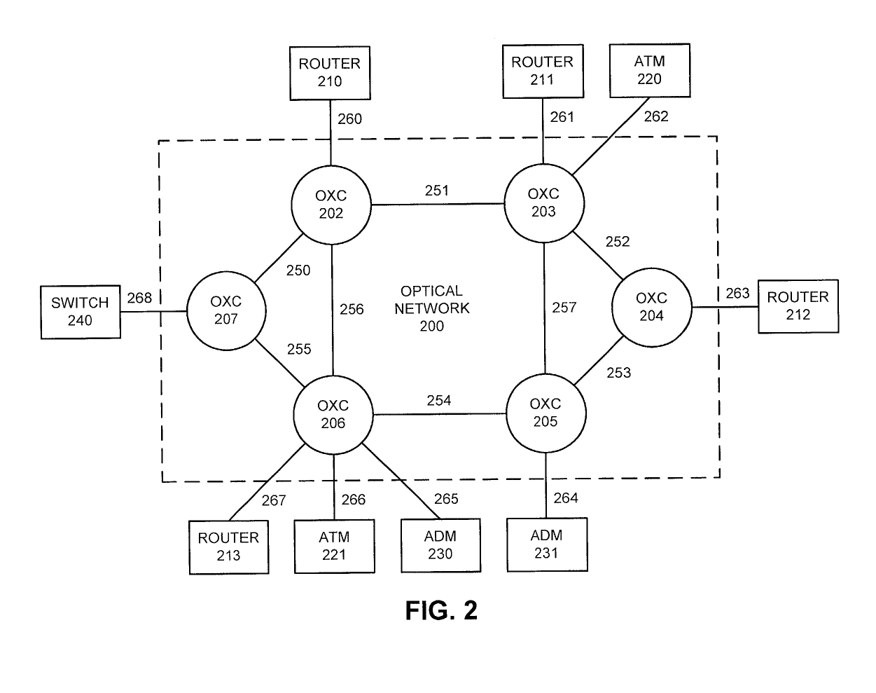

FIG. 2 illustrates an optical network 200 containing optical cross-connects 202-207 (OXCs) in accordance with an embodiment of the present invention. Optical cross-connects 202-207 are coupled to each other through a number of communications links 250-257. Each of these communication links 250-257 contains one or more optical fibers that carry wavelength-division multiplexed (WDM) signals between optical cross-connects 202-207.

Note that optical cross-connects 202-207 can be coupled to “edge devices,” such as Internet protocol (IP) routers 210-213, add-drop multiplexers (ADMs) 230-231, asynchronous transfer mode (ATM) switches 220-221, and other switches 240. Each of these edge devices is coupled, either directly or indirectly, to a number of computer systems or communications devices that send and receive communications through optical network 200.

By appropriately performing routing and wavelength assignments through optical cross-connects 202-207, an optical connection can be established to create logical (or virtual) neighbors out of edge devices that are geographically far apart in the network. For example, an optical connection can be established from router 213 to router 211 by establishing a connection that passes through communication link 267, optical cross-connect 206, communication link 254, optical cross-connect 205, communication link 257, optical cross-connect 203 and communication link 261. At each optical cross-connect along the way it is possible to switch the connection to a different wavelength on a different communication link.

Optical Cross-Connect

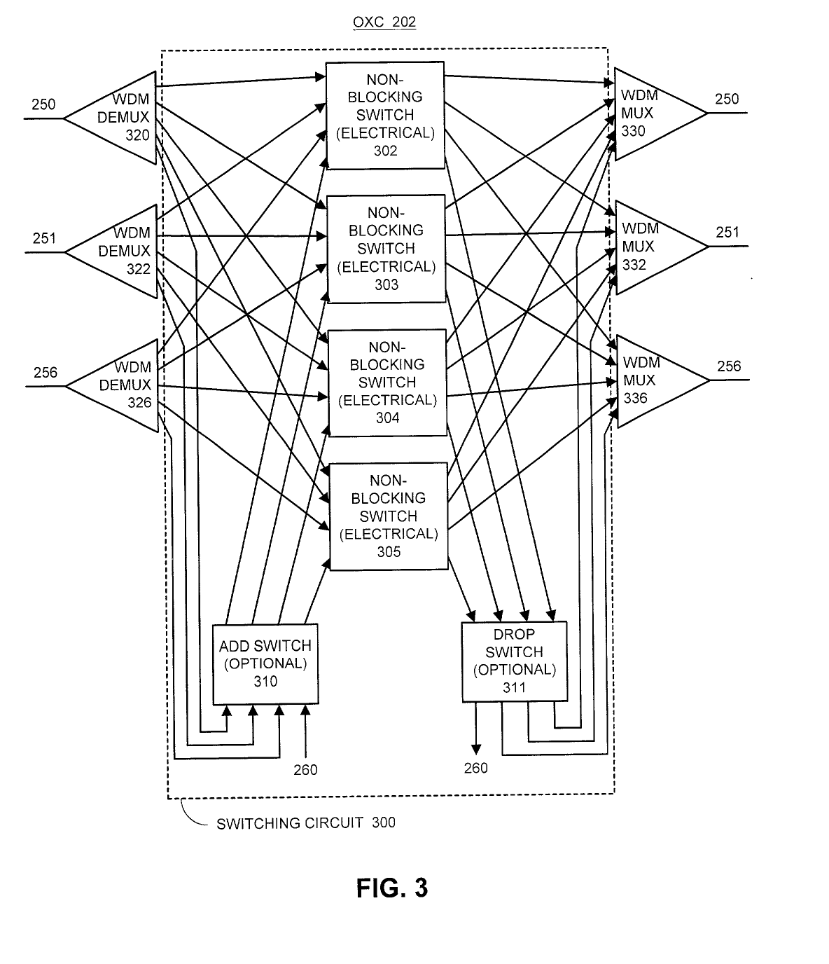

FIG. 3 illustrates an exemplary optical cross-connect 202 in accordance with an embodiment of the present invention. Optical cross-connect 202 communicates through communication link 250 to optical cross-connect 207; through communication link 256 to optical cross-connect 206; and through communication link 251 to optical cross-connect 203. Optical cross-connect 202 also communicates with router 210 through communication link 260.

On the left-hand-side of FIG. 3, optical fibers from communication links 250, 251 and 256 feed into WDM demultiplexers 320, 322 and 326, respectively. Each of these WDM demultiplexers 320, 322 and 326 separates signals on different WDM channels carried on different frequencies from the optical fiber into separate outputs.

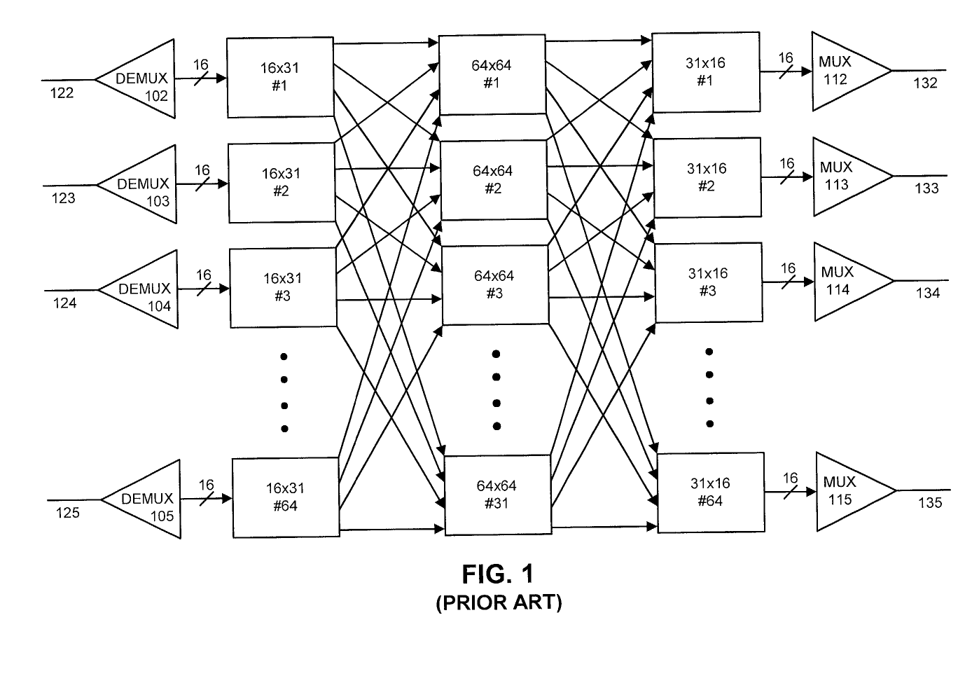

The outputs of WDM demultiplexers 320, 322 and 326 feed into a switching circuit 300 (also referred to as a “switch fabric”) comprised of non-blocking switches 302-305. In the embodiment of the present invention illustrated in FIG. 1, the non-blocking switches are electrical. This means that a conversion between optical and electrical signals takes place at some point between WDM demultiplexers 320, 322 and 326 and non-blocking switches 302-305.

In one embodiment of the present invention, each of the WDM demultiplexers 320, 322 and 326 converts a WDM signal into a plurality of 1310 nanometer (nm) optical signals, wherein there is a separate 1310 nm optical signal for each WDM channel. (Note that instead of 1310 nm signals, different wavelength signals can also be used, such as 850 nm signals or 1550 nm signals.) Next, each of these 1310 nm optical signals feeds into a converter that converts the 1310 nm optical signal into an electrical signal that feeds into one of nonblocking switches 302-305.

Non-blocking switches 302-305 are used to switch inputs received from WDM demultiplexers 320, 322 and 326 into output signals that are distributed to WDM multiplexers 330, 332 and 336. In one embodiment of the present invention, non-blocking switches 302-305 are implemented using cross-bar switches.

WDM multiplexers 330, 332 and 336 convert the outputs of non-blocking switches 302-305 back into WDM optical form to produce WDM optical signals that feed through communication links 250, 251 and 256 to neighboring optical cross-connects, 207, 203 and 206, respectively. Note that at some point between non-blocking switches 302-305 and WDM multiplexers 330, 332 and 336, the electrical signals from non-blocking switches 302-305 are converted back into single-wavelength optical form.

Add/Drop Switches

The optical cross-connect illustrated in FIG. 3 can be optionally augmented to include add switch 310 and drop switch 311. Add switch 310 can receive inputs from WDM demultiplexers 320, 322 and 326, as well as from communication link 260 going to an edge device, such as router 210 (see FIG. 2). Add switch 310 switches these input signals to produce output signals that are routed to non-blocking switches 302-305.

Some of the outputs of non-blocking switches 302-305 become inputs to drop switch 311. Drop switch 311 switches these inputs to produce outputs that are directed to WDM multiplexers 330, 332 and 336, as well as to communication link 260, which is coupled to router 210.

Note that the combination of add switch 310 and drop switch 311 provide additional pathways through optical cross-connect 202 that can be used to augment the pathways that pass through only a single non-blocking switch.

Implementation

Note that an implementation of the hardware described in the previous section can be larger than the example illustrated in FIG. 3. For example, in one embodiment of the present invention, an optical cross-connect that switches 1024 inputs between 1024 outputs is built out of a single column of eight 128×128 non-blocking switching elements. This optical cross-connect receives eight WDM optical inputs, and each of these WDM optical inputs is demultiplexed into 128 single-wavelength optical signals that feed into the 128×128 non-blocking switching elements. The outputs of the eight 128×128 non-blocking switching elements feed into eight 128-to-one WDM multiplexers.

In this embodiment, each of the eight WDM demultiplexers sends 16 single-wavelength inputs to each of the 128×128 switching elements. Conversely, each the of the eight 128×128 non-blocking switching elements sends 16 single-wavelength output signals to each of the 128-to-one WDM multiplexers.

In another embodiment of the present invention, one of the eight WDM demultiplexers is replaced with an add switch that receives inputs from the remaining seven WDM demultiplexers, as well as from various edge devices. Outputs from the add switch are routed to the eight 128×128 non-blocking switches. Similarly, one of the eight WDM multiplexers is replaced by a drop switch that receives input signals from the eight 128×128 non-blocking switches. Outputs from the drop switch are routed to the remaining seven 128-to-one multiplexers, as well as to the various edge devices.

Although the present invention is described in terms of the switching circuit illustrated in FIG. 3, the present invention is not meant to be limited to such a switching circuit with a single column of switching elements. In general, the present invention can be used with any type of switching circuit that switches a number of inputs to a number of outputs. For example, switching circuit 300 may be implemented as a multi-stage Clos network, as is illustrated in FIG. 1 or may be implemented as a large crossbar switch.

Parallel Switching Circuit

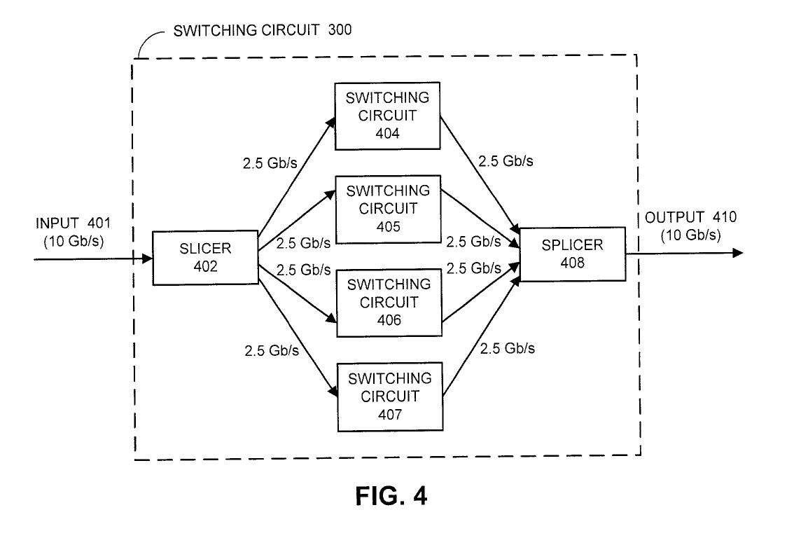

FIG. 4 illustrates a switching circuit 300 made up of multiple lower-bandwidth switching circuits 404-407 operating in parallel in accordance with an embodiment of the present invention. In this embodiment, a 10 G bit/second input signal 401 feeds into a slicer 402, which divides input signal 401 into four 2.5 G bit/second signals (slices) that feed into switching circuits 404-407.

On the right-hand side of FIG. 4, four 2.5 G bit/second outputs from switching circuits 404-407 feed into splicer 408, which splices the four signals into a single 10 G bit/second output signal 410.

By splitting the 10 G bit/second input signal in this way, it is possible to use slower speed 2.5 G bit/second switching circuits 404-407 that operate in parallel to perform the switching.

Note that switching circuit 300 additionally includes other slicers that distribute other input signals into switching circuits 404-407, as well as other splicers that produce output signals. However, these other slicers and splicers are not illustrated in FIG. 4 for purposes of clarity. In one embodiment of the present invention, there is one slicer for each of 128 inputs to switching circuit 300, and one data splicer for each of 128 outputs from switching circuit 300. This configuration allows switching circuit 300 to switch 128 incoming data streams, each of which supports a 10 G bit/second transfer rate.

In one embodiment of the present invention, switching circuits 404-407 are located on separate circuit cards (or modules), while slicer 402 and splicer 408 are located on a port card. These cards communicate with each other through a backplane within a chassis.

Slicer

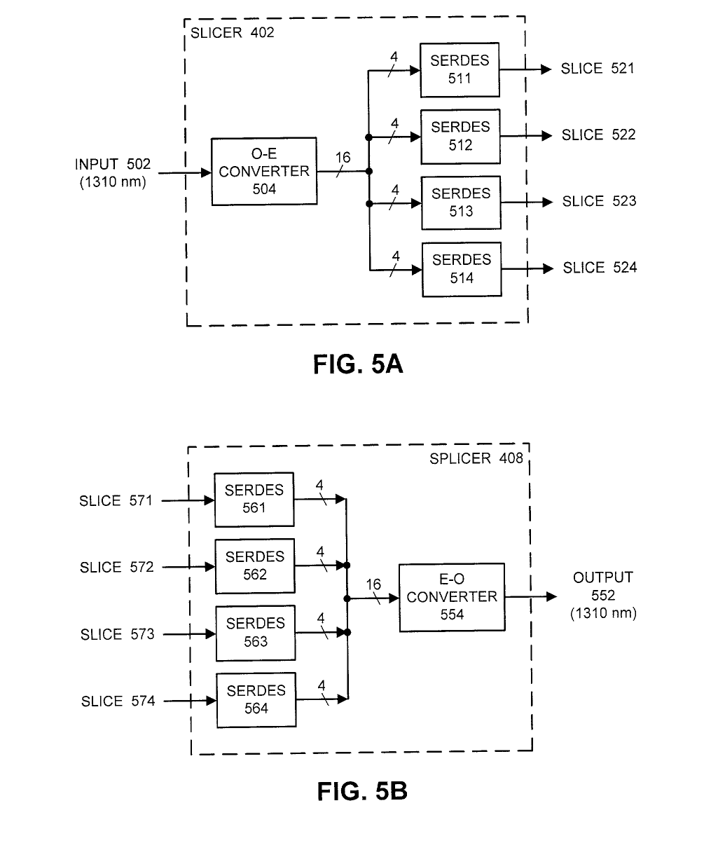

FIG. 5A illustrates the structure of slicer 402 in accordance with an embodiment of the present invention. Slicer 402 receives an optical input signal 502, which is fed through an optical-to-electrical (O-E) converter 504 to produce 16 electrical signals. These 16 electrical signals are divided into four groups of four signals and each, and each group feeds through one of four serializer/deserializers (SERDESs) 511-514 to produce four slice signals 521-524, which feed into switching circuits 404-407.

Splicer

FIG. 5B illustrates the structure of a splicer 408 in accordance with an embodiment of the present invention. Splicer 408 receives four slice signals 571-574 and feeds them through SERDES units 561-564 to produce 16 signals, which feed through electrical-to-optical (E-O) converter 554 to produce optical output signal 552.

In one embodiment of the present invention, slicer 402 and splicer 408 reside on the same line card. In this embodiment, O-E converter 504 and E-O converter 554 are located within the same bi-directional converter unit. Furthermore, SERDES units 511-514 are the same units as SERDES units 561-564 (where the SERDES units are also bi-directional).

Splicer 408 also includes special circuitry to synchronize the four incoming lanes of traffic. If there is no path delay skew across the four lanes as received at splicer 408, the special circuitry is not needed. However if there is a small skew in path delay across the four lanes as they are received at splicer 408, the special circuitry synchronizes traffic on the four lanes to eliminate skew. This synchronization may be accomplished by queuing, and by inserting special “synchronization characters” in the lanes coming out of slicer 402 at a regular time interval. Note that skew across the four lanes has to be less than this time interval for this synchronization mechanism to function properly.

Switching Process

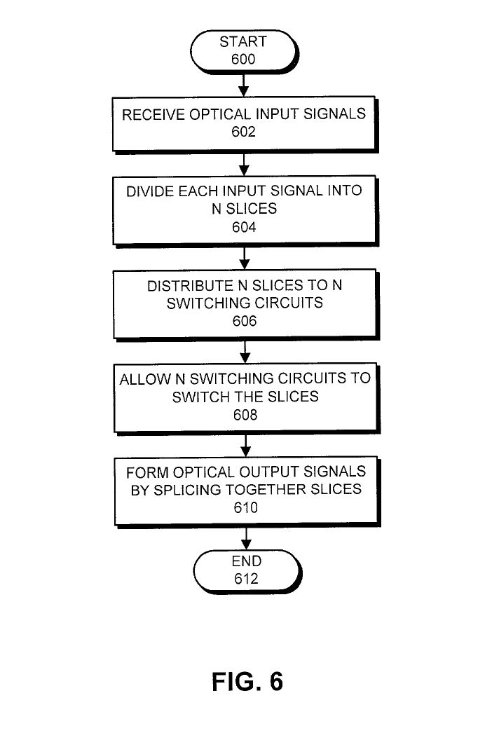

FIG. 6 presents a flow chart of the switching process in accordance with an embodiment of the present invention. The system starts by receiving a plurality of optical input signals (step 602). Next, the system divides each of these input signals into N slices (step 604), and distributes the N slices to N switching circuits (step 606).

The system then allows the N switching circuits to switch the slices (step 608). Next, the system forms optical output signals by splicing together slices from the switching circuits (step 610).

Switching Circuit with Grooming Capability

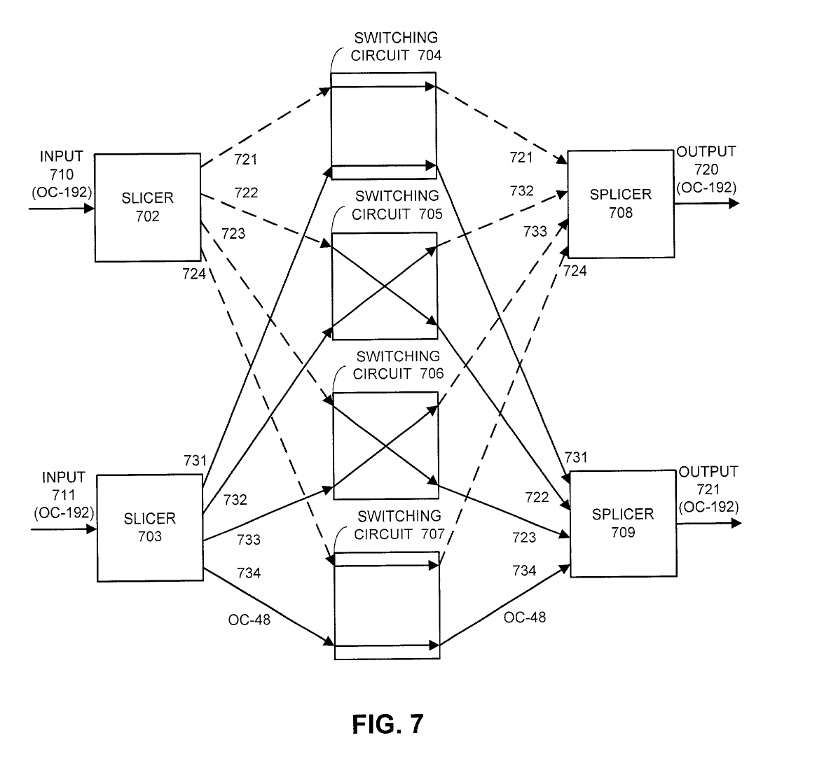

FIG. 7 illustrates a switching circuit with traffic grooming capability in accordance with an embodiment of the present invention. “Traffic grooming” refers to the process of handling sub-streams of data within a combined stream of data. For example, assume that input signal 710 has an OC-192 transfer rate and is composed of four constituent OC-48 sub-streams. Input signal 710 is demultiplexed into the four constituent OC-48 streams at slicer 702, and the four OC-48 streams are sent to four separate switching circuits 704-707. After the switching takes place, four OC-48 outputs from the switching circuits 704-707 are multiplexed together at a splicer 708 to create a single OC-192 output signal 720.

Note that every OC-192 input to the switching circuits 704-707 is associated with its own slicer, and every OC-192 output from the switching circuits 704-707 is associated with its own splicer. FIG. 7 illustrates one additional input signal 711, which feeds through slicer 703, and one additional output signal 721, which is created by splicer 709. However, in general there can be many additional input signals and corresponding slicers, as well as many additional output signals and corresponding splicers.

Since the four switching circuits 704-707 can be configured independently, it is possible to mix and match constituent OC-48 streams belonging to different OC-192 input streams to produce OC-192 outputs.

For example, in FIG. 7, output signal 720 is a groomed OC-192 combination of four OC-48 constituents, including signals 721 and 724 from input signal 710, as well as 732 and 733 from input signal 711. Similarly, output signal 721 is a groomed OC-192 combination of four OC-48 constituents, including signals 722 and 723 from input signal 710, as well as 731 and 734 from input signal 711.

Note that the switching structure illustrated in FIG. 7 can accomplish grooming of four sub-streams of OC-48 traffic into one stream of OC-192 traffic. In another embodiment of the present invention, the switching structure is composed of 16 instances of 128×128 non-blocking switch elements. This switching structure can accomplish grooming of 16 sub-streams of OC-12 traffic into one stream of OC-192 traffic.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for switching signals between optical fibers, comprising:
receiving a plurality of optical input signals;
dividing each of the plurality of optical input signals into N input slices, wherein each input slice carries l Nth of the data for a given input signal;
distributing the N input slices to N switching circuits, so that the N input slices can be switched in parallel;
allowing the N switching circuits to switch the N input slices to N corresponding output slices; and
forming a plurality of optical output signals, wherein a given optical output signal is formed by,
receiving N output slices from the N switching circuits, and
splicing the N output slices together to form the given optical output signal.

2. The method of claim 1, wherein the N switching circuits are configured in exactly the same way, so that all of the N input slices in a given optical input signal are switched to the same optical output signal.

3. The method of claim 1, wherein the N switching circuits can be configured independently, thereby allowing each of the N input slices in a given optical input signal to be switched to different optical output signals.

4. The method of claim 3, wherein each optical input signal can carry N constituent sub-streams that can be independently switched to different optical output signals.

5. The method of claim 1, wherein splicing the N output slices together involves compensating for skew through the N switching circuits.

6. The method of claim 5, wherein compensating for skew involves aligning synchronization characters that are periodically inserted into input slices.

7. The method of claim 1,
wherein dividing each of the plurality of optical input signals into N input slices involves converting the plurality of optical input signals from optical form into electrical form; and
wherein splicing the N output slices together to form the given optical output signal involves converting the given optical output signal from electrical form into optical form.

8. The method of claim 1,
wherein the plurality of optical input signals are received from a plurality of neighboring nodes in an optical network; and
wherein the plurality of optical output signals are directed to the plurality of neighboring nodes in the optical network.

9. The method of claim 1,
wherein dividing each of the plurality of optical input signals into N input slices involves performing a serial-to-parallel conversion on each of the plurality of optical input signals; and
wherein forming a plurality of optical output signals involves performing a parallel-to-serial conversion to form each of the plurality of optical output signals.

10. The method of claim 1, wherein each optical input signal supports at least one of the following standard Synchronous Optical Network (SONET) transfer rates: STS-1; OC-3; OC-12; OC-48; OC-192; OC-768; OC-1536; and OC-3072.

11. The method of claim 1, wherein each of the N switching circuits can include, a single column of switching elements, a crossbar switch or a multistage network.

12. An apparatus for switching signals between optical fibers, comprising:
a plurality of inputs that are configured to receive a plurality of optical input signals;
a slicer that is configured to divide a given optical input signal into N input slices, wherein each input slice carries 1/Nth of the data for a given optical input signal;
N switching circuits that are configured to receive the N input slices from each of the plurality of optical input signals, and to switch the N input slices in parallel to N corresponding output slices;
a splicer that is configured to,
receive N output slices for a given optical output signal from the N switching circuits, and to
splice the N output slices together to form the given optical output signal; and
a plurality of outputs that are configured to provide a plurality of optical output signals.

13. The apparatus of claim 12, wherein the N switching circuits are configured in exactly the same way, so that all of the N input slices in the given optical input signal are switched to the same optical output signal.

14. The apparatus of claim 12, wherein the N switching circuits can be configured independently, thereby allowing each of the N input slices in the given optical input signal to be switched to different optical output signals.

15. The apparatus of claim 14, wherein each optical input signal can carry N constituent sub-streams that can be independently switched to different optical output signals.

16. The apparatus of claim 12, wherein the splicer is configured to compensate for skew through the N switching circuits.

17. The apparatus of claim 16, wherein the splicer is configured to compensate for skew by aligning synchronization characters that are periodically inserted into input slices.

18. The apparatus of claim 12,
wherein the slicer is configured to convert the given optical input signal from optical form into electrical form; and
wherein the splicer is configured to convert the given optical output signal from electrical form into optical form.

19. The apparatus of claim 12,
wherein the plurality of optical input signals are received from a plurality of neighboring nodes in an optical network; and
wherein the plurality of optical output signals are directed to the plurality of neighboring nodes in the optical network.

20. The apparatus of claim 12,
wherein the slicer is configured to perform a serial-to-parallel conversion on the given optical input signal; and
wherein the splicer is configured to perform a parallel-to-serial conversion to form the given optical output signal.

21. The apparatus of claim 12, wherein each optical input signal supports at least one of the following standard Synchronous Optical Network (SONET) transfer rates: STS-1; OC-3; OC-12; OC-48; OC-192; OC-768; OC-1536; and OC-3072.

22. The apparatus of claim 12, wherein each of the N switching circuits can include, a single column of switching elements, a crossbar switch or a multi-stage network.

23. An optical network, comprising a plurality of optical cross-connects that are coupled together to form the optical network, wherein each optical cross-connect includes:
a plurality of inputs that are configured to receive a plurality of optical input signals;
a slicer that is configured to divide a given optical input signal into N input slices, wherein each input slice carries 1/Nth of the data for a given optical input signal;
N switching circuits that are configured to receive the N input slices from each of the plurality of optical input signals, and to switch the N input slices in parallel to N corresponding output slices;
a splicer that is configured to,
receive N output slices for a given optical output signal from the N switching circuits, and to
splice the N output slices together to form the given optical output signal; and
a plurality of outputs that are configured to provide a plurality of optical output signals.

24. The optical network of claim 23, wherein the N switching circuits are configured in exactly the same way, so that all of the N input slices in the given optical input signal are switched to the same optical output signal.

25. The optical network of claim 23, wherein the N switching circuits can be configured independently, thereby allowing each of the N input slices in the given optical input signal to be switched to different optical output signals.

26. The optical network of claim 25, wherein each optical input signal can carry N constituent sub-streams that can be independently switched to different optical output signals.

27. The optical network of claim 23, wherein the splicer is configured to compensate for skew through the N switching circuits.

28. The optical network of claim 27, wherein the splicer is configured to compensate for skew by aligning synchronization characters that are periodically inserted into input slices.

29. The optical network of claim 23,
wherein the slicer is configured to convert the given optical input signal from optical form into electrical form; and
wherein the splicer is configured to convert the given optical output signal from electrical form into optical form.

30. The optical network of claim 23,
wherein the plurality of optical input signals are received from a plurality of neighboring nodes in an optical network; and
wherein the plurality of optical output signals are directed to the plurality of neighboring nodes in the optical network.

31. The optical network of claim 23,
wherein the slicer is configured to perform a serial-to-parallel conversion on the given optical input signal; and
wherein the splicer is configured to perform a parallel-to-serial conversion to form the given optical output signal.

32. The optical network of claim 23, wherein each optical input signal supports at least one of the following standard Synchronous Optical Network (SONET) transfer rates: STS-1; OC-3; OC-12; OC-48; OC-192; OC-768; OC-1536; and OC-3072.

33. The optical network of claim 23, wherein each of the N switching circuits can include, a single column of switching elements, a crossbar switch or a multi-stage network.
